(19) United States
(12) Patent Application Publication
(10) Pub. No.: US 2017/0320196 A1
(43) Pub. Date: Nov. 9, 2017

(54) Gas Valve Socket to Turn On or Off Gas Line

(71) Applicant: VINTON WOLFE, BURBANK, CA (US)

(72) Inventor: VINTON WOLFE, BURBANK, CA (US)

(21) Appl. No.: 15/583,219

(22) Filed: May 1, 2017

Related U.S. Application Data
(60) Provisional application No. 62/331,210, filed on May 3, 2016.

(51) Int. Cl. B25B 13/48; B25B 23/00; B25B 13/46

(52) U.S. Cl. CPC B25B 13/481; B25B 13/461; B25B 23/0021

(57) ABSTRACT

A gas valve blade socket for use by a socket wrench to turn on and off a gas line valve, including: a tubular body, with a flat top and bottom, and a vertical side wall; a top cover section positioned on the top; a bottom cover section positioned on the bottom; a cavity formed within the tubular body and between the top and bottom cover sections; an elongated rectangular slot formed in the top cover section and extending to the cavity, having a shape sufficiently sized to fit over a gas line valve blade; and a rectangular opening formed in the bottom cover section and extending to the cavity.

### CROSS REFERENCE TO RELATED APPLICATIONS

This application claims the benefit of copending U.S. Provisional Application No. 62/331,210, having the same inventor, filed May 3, 2016, titled: “GAS VALVE SOCKET TO TURN ON OR OFF GAS LINE.”

### FEDERALLY SPONSORED RESEARCH AND DEVELOPMENT

Not Applicable

### MICROFICHE APPENDIX

Not Applicable

### BACKGROUND OF THE INVENTION

### (1) Field of the Invention

The present invention relates generally to the field of gas line valve attachment devices and more specifically relates to a ratcheting socket wrench, an extension bar, and a set of adapters that may rapidly turn on or off different types of gas line valves in hard to reach places.

### (2) Background of the Invention

Many industrial fasteners require the use of a tool to apply a leveraged force to open or close a fastener. A socket wrench is a type of wrench that has a replaceable socket attached at the end that is used to turn a fastener. The most common type of socket wrench is called a ratcheting socket wrench, also known as a ratchet. The ratcheting action allows the ratchet handle to be repositioned as needed while not turning a socket. This allows the fastener to be rapidly tightened or loosened is small increments. A gas pipe line valve is conventionally opened by providing a torque upon a long rod that attaches to a valve. As such, an improvement to a gas pipe line valve tool to provide a ratcheting function is needed.

Various attempts have been made to solve problems found in socket devices art. The following prior art are representative of gas line socket devices, and are herein incorporated by reference for their supportive teachings, in which include: U.S. Pat. No. 8,065,938 to Nick C. Kravitch; U.S. Publication No. 2010/0236364 to Lisa Leighton; and U.S. Publication No. 2006/0042427 to Maynard Walters.

None of the known prior art teach singly or in combination the advantages of the herein disclosed illustrated embodiments of the present invention.

### SUMMARY OF THE ILLUSTRATED EMBODIMENTS

In view of the foregoing disadvantages inherent in the known types of apparatus like in the prior art, the present invention provides an improved apparatus. As such, the general purpose of the present invention, which will be described subsequently in greater detail, is to provide a new and improved apparatus with all the advantages of the prior art and none of the disadvantages.

In view of the foregoing disadvantages inherent in the known art, the present invention provides a novel Gas Valve Socket to Turn On or Off a Gas Line. The general purpose of the present invention, which will be described subsequently in greater detail, is to provide an adapter capable of attaching to a ratchet socket wrench that may couple with a variety of gas line valves in order to turn the valves on or off. An extension bar may also be provided which the adapters may attach to. The ratcheting feature and extension bar of the present invention may allow a user to turn on or off gas line valves in hard to reach places.

In a potential embodiment of the invention there is a gas valve blade socket for use by a socket wrench to turn on and off a gas line valve, including: a tubular body, with a flat top and bottom, and a vertical side wall; a top cover section positioned on the top; a bottom cover section positioned on the bottom; a cavity formed within the tubular body and between the top and bottom cover sections; an elongated rectangular slot formed in the top cover section and extending to the cavity, having a shape sufficiently sized to fit over a gas line valve blade; and a rectangular opening formed in the bottom cover section and extending to the cavity.

The gas valve blade socket may also include the top and bottom cover sections are positioned to be parallel to each other. The gas valve blade socket may also include the vertical side wall is perpendicular to the top and bottom cover sections. The gas valve blade socket may also include the gas valve blade socket is made of a ridged material, selected from the group consisting of steel, iron, stainless steel, aluminum, nickel, cobalt, or hardened steel. There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows a perspective view illustrating the ratcheting socket wrench, the extension bar, and the adapters of the Gas Valve Socket to Turn On or Off Gas Line according to an embodiment of the present invention.

FIG. 2 shows a perspective view illustrating the ratcheting socket wrench, the extension bar, and the adapters of the Gas Valve Socket to Turn On or Off Gas Line according to an embodiment of the present invention.

FIG. 3 shows a perspective view illustrating the adapters of the Gas Valve Socket to Turn On or Off Gas Line according to an embodiment of the present invention.

FIG. 4 shows a perspective view of a gas valve blade socket for use by a socket wrench to turn on and off a gas line valve.

FIG. 5 shows a top view of FIG. 4.

FIG. 6 shows a bottom view of FIG. 4.

FIG. 7 shows a vertical cross sectional view of FIG. 4.

FIG. 8 shows a side view of an alternative embodiment of the gas valve socket of FIG. 4.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

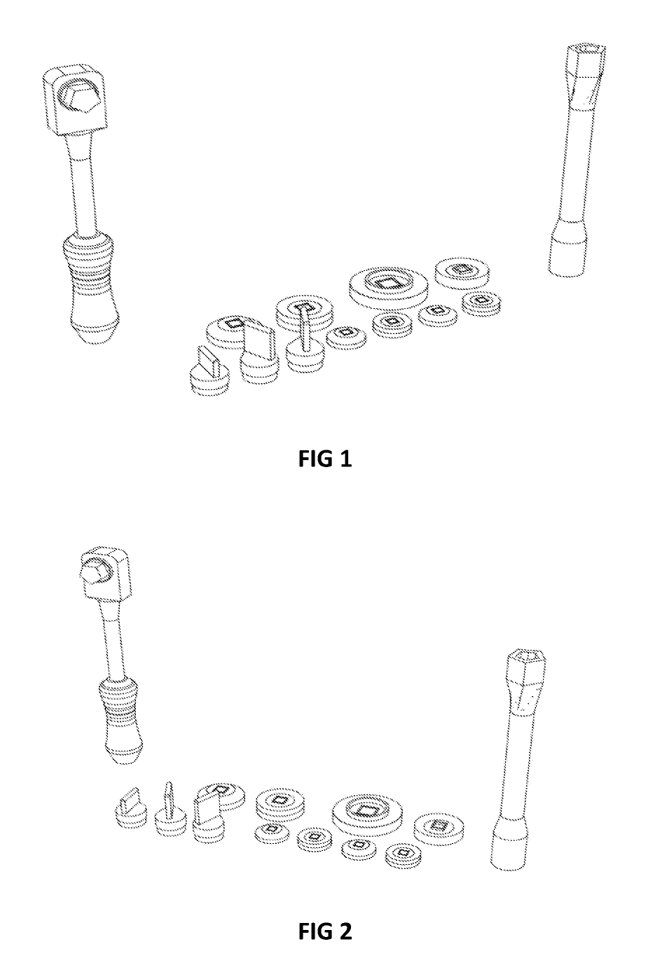

Turning now to FIG. 1, the present invention discloses a As discussed above, embodiments of the present invention relate to a gas line valve attachment kit and more particularly to a Gas Valve Socket to Turn On or Off Gas Line.

Referring now to the drawings FIGS. 1-3, the present invention may comprise a ratcheting socket wrench, an extension bar, and at least one adapter. The ratcheting socket wrench of the present invention may comprise a handle attached to a ratcheting mechanism. The ratcheting socket wrench may comprise two opposing features when turned clockwise or counterclockwise by a user. The handle may be repositioned in small increments via turning the handle clockwise or counterclockwise. The ratcheting mechanism, when turned in the opposing direction, may tighten or loosen a fastener or other member in small increments. Due to the incremental repositioning and incremental tightening or loosening features of the ratcheting socket wrench, a user may tighten or loosen a fastener, valve, or other member in a confined space. The ratcheting socket wrench may embody a conventional ratcheting socket wrench.

The extension bar of the present invention may comprise an extender rod which may removably attach to the ratchet socket wrench and a plurality of different sockets and adapters. The extension bar may also provide added length for a sockets and adapters such that a user may couple the present invention to fasteners, valves, and other members in hard to reach places.

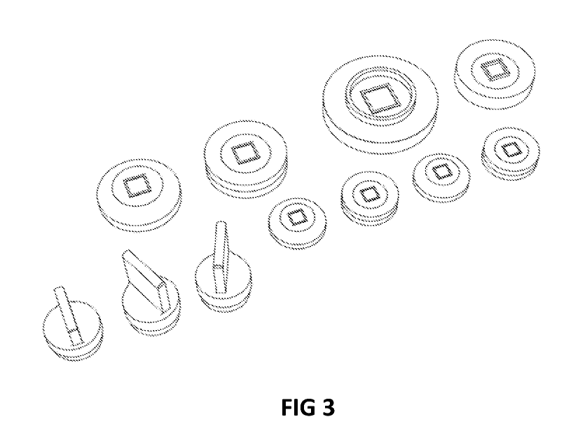

The at least one adapter of the present invention may comprise a set of 11 adapters, as shown in FIG. 3. Each of the 11 adapters may be designed to attach to the ratcheting socket wrench, or the extension bar in a manner similar to that of a conventional socket. Each of the 11 adapters may also be designed to couple with a plurality of different gas line valves including but not limited to a gate valve, a butterfly valve, a check valve, a globe valve, a piston valve, and a plug valve. The adapters of the present invention may couple with a gas line valve in a manner such that the rotating of the adapter via the ratchet socket wrench may turn the gas line valve to a closed/off or open/on configuration. Each of the 11 adapters may be manufactured of a plurality of different sizes in order to accommodate different gas line valves.

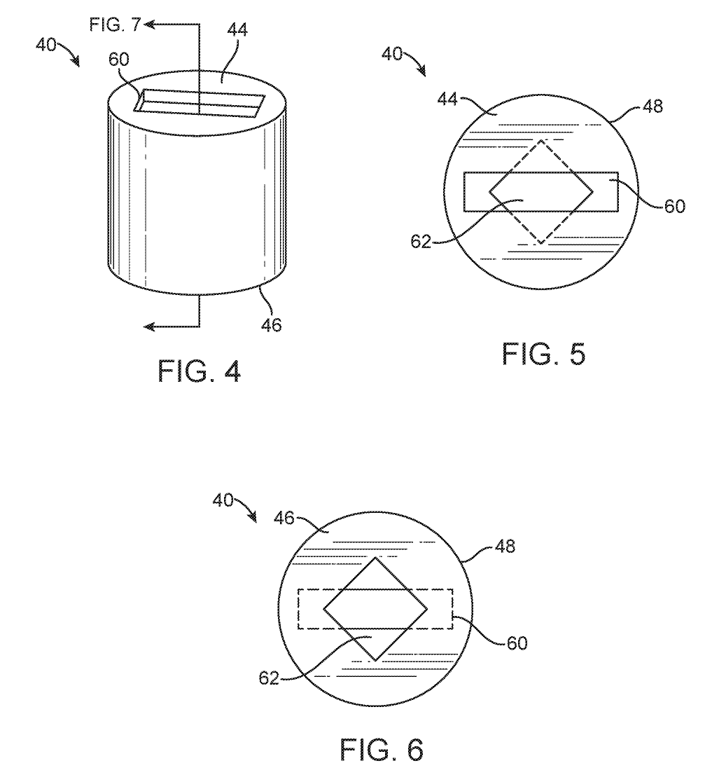

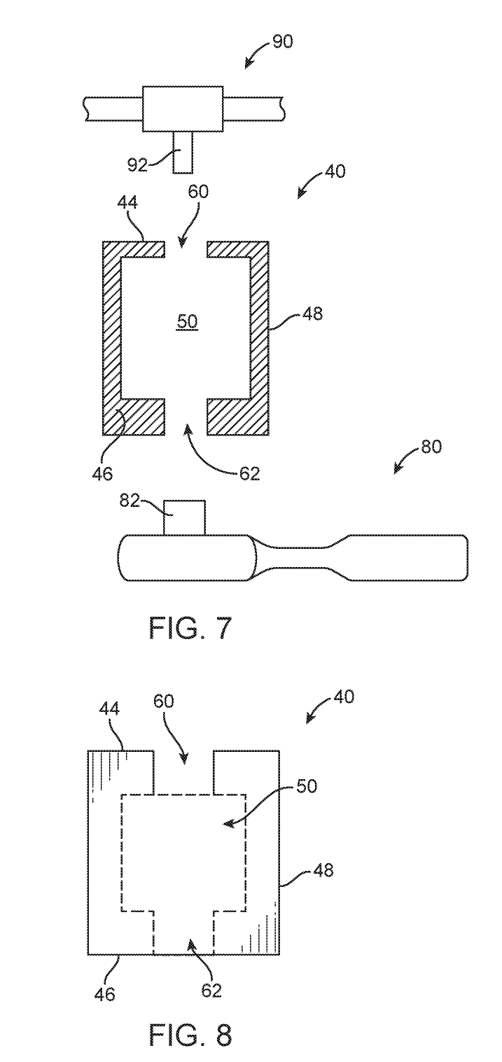

FIGS. 4-8 shows a perspective, top, bottom and vertical cross sectional views of a gas valve blade socket 40 for use by a socket wrench to turn on and off a gas line valve 90. In particular, the socket 40 has a tubular body shape, with vertical side wall 48. Additionally, there is a flat top cover section 44 and a flat bottom cover section 46 positioned opposite to the top cover section 44; a cavity 50 is formed within the socket 40 and between the top 44 and bottom 46 cover sections; an elongated rectangular slot 60 is formed in the top cover section 44 and extending to the cavity 50, having a shape sufficiently sized to fit over a gas line valve blade 92; and a rectangular opening 62 formed in the bottom cover section 46 and extending to the cavity 50 to allow for engagement with a standard ratchet wrench 80 and the square post 82 typically extending therefrom for engagement with the socket's 40 rectangular opening 62 for ratchet operation in known fashion.

It is noted that the top 44 and bottom 46 cover sections are positioned to be parallel to each other, and the vertical side wall 48 is perpendicular to the top 44 and bottom 46 cover sections. Moreover, the vertical side wall spaces the top and bottom cover sections 44 and 46 from each other by at least two times the thickness of the bottom cover section 46 to enable the ratchet connection bit 82 to extend thereinto the cavity 50. It is also noted that the gas valve blade socket 40 is made of any known ridged material, for example it may be selected from the group consisting of steel, iron, stainless steel, aluminum, nickel, cobalt, or hardened steel.

Additionally, focusing on FIG. 8, there is a side view of an alternative embodiment of the gas valve socket 40 may have the elongated rectangular slot 60 be designed to not have one or both ends caped, thus not to prevent a longer in length gas blade from being mounted therethrough the slot 60.

The present invention may be useful for turning on or off gas lines in hard to reach places, including on sidewalks, under houses, and behind water heaters. The present invention may be especially useful in emergency situations. Conventional gas line valve tools may require a 180 degree or 360 degree repositioning turn in order to properly function. Conventional gas line valves may also be large and cumbersome. The present invention may provide a feasible, rapid, more compact, and more light weight means to turn on or off a gas line valve.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptions or variations of the present invention.

Although the invention has been explained in relation to its preferred embodiment, it is to be understood that many other possible modifications and variations can be made without departing from the spirit and scope of the invention.

I/We claim:

1. A gas valve blade socket for use by a socket wrench to turn on and off a gas line valve, including:
a. a tubular body, with a flat top and bottom, and a vertical side wall;
b. a top cover section positioned on the top;
c. a bottom cover section positioned on the bottom;
d. a cavity formed within the tubular body and between the top and bottom cover sections;
e. an elongated rectangular slot formed in the top cover section and extending to the cavity, having a shape sufficiently sized to fit over a gas line valve blade; and
f. a rectangular opening formed in the bottom cover section and extending to the cavity.

2. The gas valve blade socket of claim 1, wherein the top and bottom cover sections are positioned to be parallel to each other.

3. The gas valve blade socket of claim 2, wherein the vertical side wall is perpendicular to the top and bottom cover sections.

4. The gas valve blade socket of claim 1, wherein the gas valve blade socket is made of a ridged material, selected from the group consisting of steel, iron, stainless steel, aluminum, nickel, cobalt, or hardened steel.

5. The gas valve blade socket of claim 3, wherein the vertical side wall spaces the top and bottom cover sections from each other by at least two times a thickness of the bottom cover section, to enable a ratchet connection bit to extend thereinto the cavity.
